(19) United States
(12) Patent Application Publication
(10) Pub. No.: US 2006/0059486 A1
(43) Pub. Date: Mar. 16, 2006

(54) Call stack capture in an interrupt driven architecture

(75) Inventors: Susan A. Loh, Atlanta, GA (US); Bor-Ming Hsieh, Redmond, WA (US); John R. Eldridge, Bellevue, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 10/940,454

(22) Filed: Sep. 14, 2004

(51) Int. Cl. G06F 9/46

(52) U.S. Cl. 718/100

(57) ABSTRACT

The present invention provides a method and system for capturing the call stack of a currently-running thread at the time a profiler interrupt occurs. The thread context of the thread is determined before a full push of the thread context is performed by the CPU architecture. The hardware state at the time of the interrupt is used to aid in determining which portions of memory to search for portions of the thread context. Based on the hardware state and the software state of the thread at the time of the interrupt the thread context is captured. Code may also be injected into a thread to capture a thread's call stack. The state of the thread is altered to induce the thread to invoke the kernel's call stack API itself, using its own context.

### BACKGROUND OF THE INVENTION

Increasing the performance of a program can be a difficult task. One piece of information that helps programmers increase the performance of their programs is knowing where a program spends its time during execution. Knowing the execution times, a programmer may make changes to the program in order to make it run more efficiently. Another piece of information that is helpful is knowing the state of the program during various points of execution.

A profiler is one tool that may be used to provide this execution information. Generally, a profiler is a separate program from the one being measured that determines, or estimates, which parts of a system are consuming the most resources while the program is executing. Some profiler tools measure the time at predetermined points within a program. For example, a profiler may determine how much time is spent within each function. In order to measure the resources being consumed, however, the program being measured must include the instrumentation necessary to measure execution times. This can result in high overhead associated with the profiler.

### SUMMARY OF THE INVENTION

The present invention is directed at capturing the call stack of a currently-running thread at the time a profiler interrupt occurs.

According to one aspect of the invention, the thread context of the thread is determined before a full push of the thread context is performed by the CPU architecture.

According to another aspect of the invention, the hardware state at the time of the interrupt is determined and used to aid in determining which portions of memory to search for portions of the thread context.

According to yet another aspect of the invention, the hardware state is used to determine the possible software states of the thread at the time of the interrupt. These software states may then be searched to capture the thread context.

According to another aspect of the invention, code is injected into a thread to help simplify the work to capture a thread's call stack. The state of the thread is altered to induce the thread to invoke the kernel's call stack API itself, using its own context.

### BRIEF DESCRIPTION OF THE DRAWINGS

FIG. 1 illustrates an exemplary computing device that may be used in exemplary embodiments of the present invention;

FIG. 2 illustrates a call stack capture system;

FIG. 3 illustrates a process flow for capturing the call stack of a thread before the context of the thread is fully pushed; and

FIG. 4 shows a process for creating the call stack, in accordance with aspects of the invention.

### DETAILED DESCRIPTION OF THE PREFERRED EMBODIMENT

Generally, The present invention is directed at providing a system and method for capturing the call stack of a currently-running thread at the time a profiler interrupt occurs.

Illustrative Operating Environment

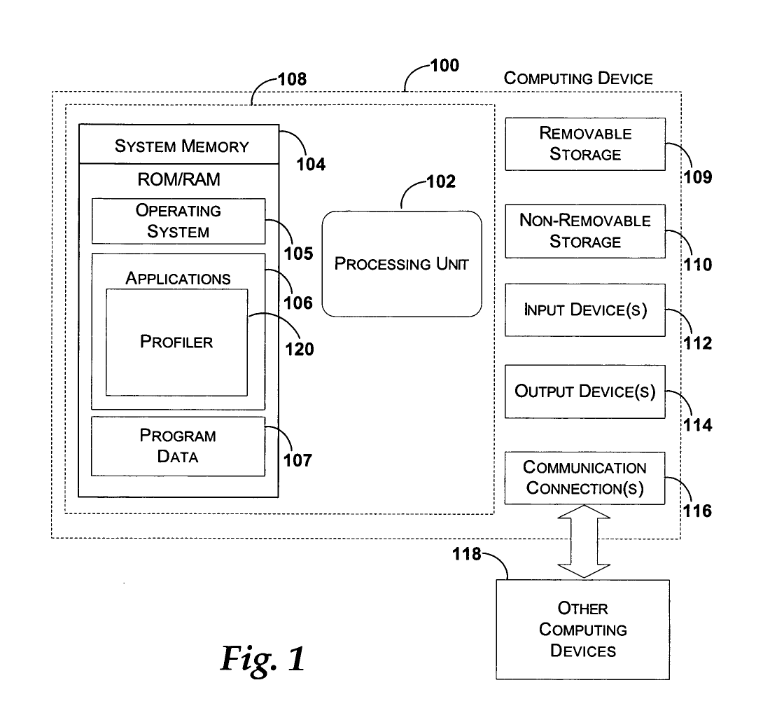

With reference to FIG. 1, one exemplary system for implementing the invention includes a computing device, such as computing device 100. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 105, one or more applications 106, and may include program data 107. In one embodiment, applications 106 may include a profiler program 120. This basic configuration is illustrated in FIG. 1 by those components within dashed line 108.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included.

Computing device 100 may also contain communication connections 116 that allow the device to communicate with other computing devices 118, such as over a network. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Illustrative Call Stack Capture System

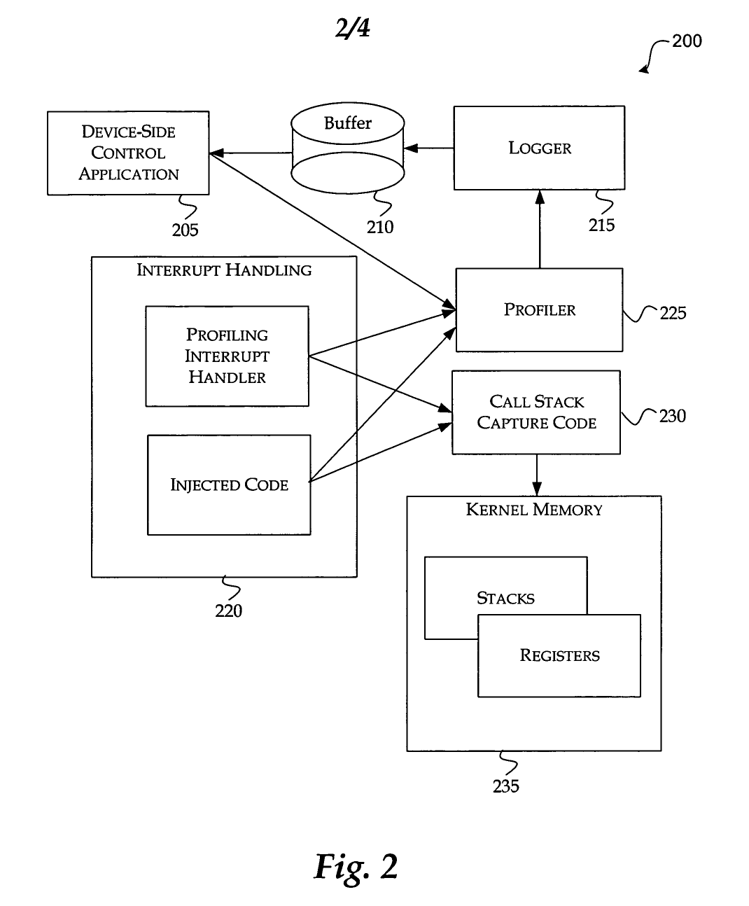

FIG. 2 illustrates a call stack capture system, in accordance with aspects of the present invention. Call stack capture system 200 is directed at obtaining a thread context for a thread within a program at the time of an interrupt before the CPU architecture pushes a full context for the thread.

The term “thread context” refers to state of a set of registers as well as other state information about the thread. The context at time of interrupt typically includes the values within CPU registers which includes status, condition flags, program counter, return address, and general purpose registers. The exact information contained within a thread context varies depending on the CPU architecture. The type of CPU architecture is also used to determine where to find portions of the thread context when the interrupt occurs.

Different CPU architectures execute programs differently and have different calling conventions as well as different ways of storing context information. Some CPU architectures assign each thread to a different stack. Other architectures use different stacks, or registers, for execution of different functions. Still other architectures split the context information for a single thread across registers and stacks. For example, some threads may use a kernel mode stack while other threads may use a kernel mode stack, a user mode stack, and a set of registers to store the context information.

Generally, a stack is used as a temporary storage area for variables and the current execution state of a thread. For example, in an x86 CPU architecture, each time a function is entered, a new stack frame is created on the stack by the processor. The stack frame for each function contains information such as the function's temporary variables and other information such as the current state of the processor registers and the return address of the routine that called the function. During execution, a frame pointer, which may be stored in a register associated with the processor, points to the currently executing function's stack frame. When a new function is called, the previous frame pointer is saved on the stack, a new stack frame is created, and the frame pointer is updated to the current function's stack frame. On the x86 architecture, the entire function call history is present on the stack and can be determined by traversing the chain of frame pointers stored on the stack. On x86 architectures at the time of the interrupt, the processor pushes the context at the time of the interrupt that goes to a known location that is easy to retrieve. This context information, however, is not so conveniently located on many other CPU architectures. Other CPU architectures store the context information in many different locations while the thread is executing. For example, some of the context information is stored in registers and some of the context information is stored across different stacks.

Referring to FIG. 2, profiler 22 generates interrupts according to a predetermined schedule. According to one embodiment, profiler 225 generates interrupts at different sampling times while a program is executing. Control application 205 may be used to set parameters, such as setting an interrupt frequency parameter, associated with profiler 225. Application 205 may also specify an interrupt handler to be run upon an interrupt. An interrupt may occur in many different places within the program. The interrupt may be interrupting a kernel call, another lower priority interrupt or interrupting some other function call.

When the interrupt occurs a program counter is examined by profiler 225 to determine which thread in a program was executing at the time of the sample. After the thread is determined, call stack capture code 230 examines the memory locations (235) containing the thread context and the portions of the thread context at the memory locations are extracted. For example, on the x86 architecture by examining the chain of stack frames the function sequence that resulted in the current execution state of the thread can be determined.

Since the interrupt handler does not initially have the thread context, the interrupt handler or call stack code 230 assembles the various registers and other information contained in the thread's context by accessing kernel memory 235 as determined by the CPU architecture.

According to another embodiment, the interrupt handler alters the state of the thread to induce the thread to invoke the kernel's call stack API itself, using its own context. The handler does this by saving some of the thread's registers into the thread's stack, and then changing the thread's program counter register to contain the address of some code which calls the kernel's call stack API, then restores the thread's saved registers from the stack and resumes what the thread was doing. This method of “injecting” code into a running thread can simplify the work required to capture the thread's call stack. The injected code also provides the call stack data to the kernel profiler API.

Since the thread might be preempted by a higher-priority thread, some additional work must be done to assure that data is logged in order, either by temporarily boosting the thread's priority to ensure that it is the highest-priority thread until it finishes logging, or by recording a timestamp during the interrupt handler, passing it to the thread to be logged along with the call stack, and then later re-ordering the profiler hits based on their timestamps.

Some code that is run by the kernel may not be accessed while it is executing. Therefore, if an interrupt occurs during this critical portion of code no information will be able to obtained relating to its context.

Debuggers and unwinders understand how to read the full context when it is contained within a single location, but do not understand how to read context when it is scattered in different portions of the kernel memory. Before the full context is determined an aggregation of the thread context is made to gather information from kernel memory 235 that includes the kernel stack, registers, banked registers (user mode, kernel mode), context structure, and the like. This aggregation occurs before a full context push has occurred.

At the time of the interrupt a program counter is generated. The hardware state, or the operating mode (user, kernel, etc.) of the processor at the time of interrupt is also available across various CPU architectures. This information is found within a known location within kernel memory 235. The operating modes, however, on each CPU architecture may be different. Capture code 230 determines the operating mode to help locate where in memory to start looking for portions of the thread context. The nesting level of the interrupt may also be determined at the time of the interrupt. For example, a nesting level equal to one means that the thread is at a single interrupt point. A nesting level of two means that an interrupt has interrupted another interrupt.

According to one embodiment, if the interrupt occurs during a kernel call, then nothing occurs until the code exits the kernel call.

Once the call stack is captured it may be logged by logger 215 and stored in store 210. The interrupt handling may take place within a profiling interrupt handler or within the interrupted thread itself. Device-side control application 205 is responsible for eventually removing the data from store 210 and either communicating it back to a profiler, saving it in a file, or performing some other operation on the data. Control application 205 may also instruct profiler 205 to stop profiling, at which point the interrupt is disabled and store 210 may be cleared.

Process for Capturing a Call Stack of a Thread

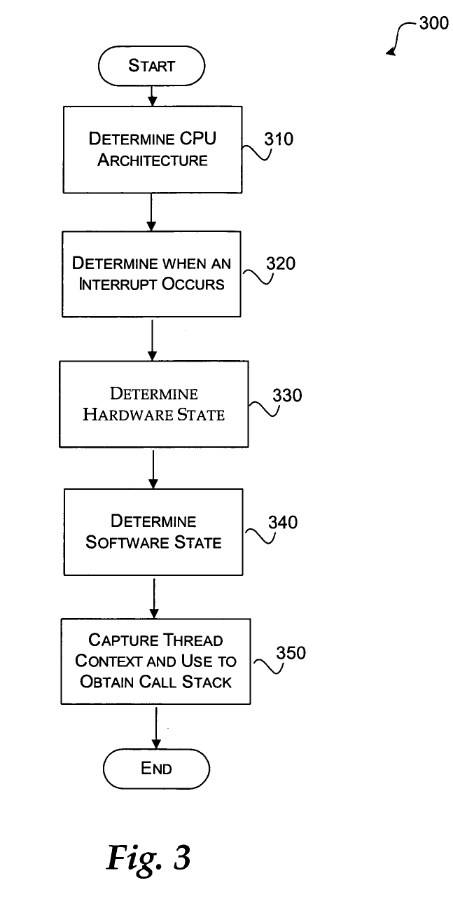

FIG. 3 illustrates a process flow for capturing the call stack of a thread before the context of the thread is fully pushed, in accordance with aspects of the invention. After a start block, the process flows to block 310 where the CPU architecture is determined. The CPU architecture determines where context information is stored. For example, one type of architecture may store context information in a single stack, whereas another architecture may store context information in different stacks and registers.

Moving to block 320, a determination is made as to when an interrupt occurs. According to one embodiment, a profiler generates interrupts at a predetermined frequency.

Flowing to block 330, the hardware state of the CPU is determined. For example, a determination may be made as to whether the CPU is operating in a user-mode or operating in the kernel-mode.

Transitioning to block 340, the software state is determined. The hardware state is used to determine the possible software states that the thread may be in at the time of the interrupt. After the possible software states are determined, each state may be examined within the system to see if it relates to the current thread. For example, one software state may store information in a certain stack location, whereas another software state may store information in another location. When the process determines the location of the current thread, the software state has been determined.

Moving to block 350, the thread context is captured and is used to obtain the call stack. Portions of the context are typically spread through a variety of stacks and registers.

The process then moves to an end block.

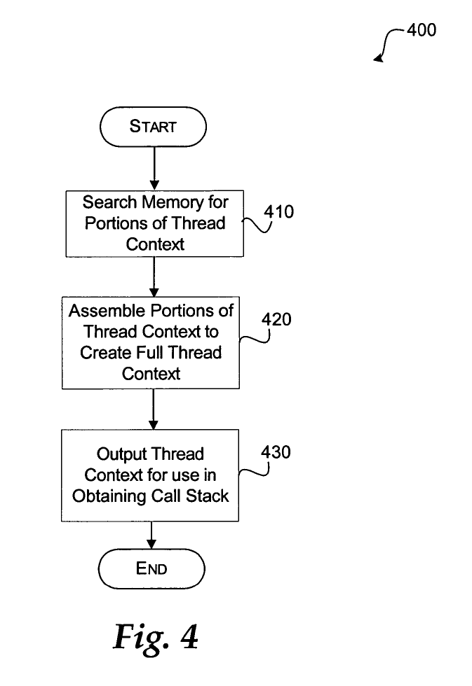

FIG. 4 shows a process for creating the call stack, in accordance with aspects of the present invention. After a start block, process 400 flows to block 410 where the memory of the system is searched for portions of the thread context. Portions of the thread context may be contained in many different memory locations. For example, some of the thread context may be stored in one stack and another portion of the thread context may be stored in a second stack. Still yet other portions of the thread context may be stored in registers. The CPU architecture determines the memory locations to be searched.

Moving to block 420, portions of the thread context are assembled to create the full thread context. Next, at block 430 the full thread context is output and is used to obtain the call stack. According to one embodiment, the full thread context is supplied to a profiler. The process then moves to an end block.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for a profiler to capture a thread context at a time of interrupt for a thread, comprising:
determining a CPU architecture on which the interrupt occurs, wherein the CPU architecture has rules, calling conventions and states associated with a processor;
determining when an interrupt occurs;
capturing the thread context before a full context is pushed by the CPU architecture; and
obtaining a call stack using the thread context.

2. The method of claim 1, further comprising injecting code into the thread to capture the thread context.

3. The method of claim 2, further comprising boosting a priority of the thread such that the thread remains uninterrupted for a period of time.

4. The method of claim 1, further comprising: determining a hardware state of the CPU architecture at the time of the interrupt; and determining a software state based on the hardware state.

5. The method of claim 4, wherein the hardware state relates to an operating mode of the processor at the time of interrupt.

6. The method of claim 5, further comprising determining a level of nesting that relates to how many times the thread has been interrupted.

7. The method of claim 5, wherein capturing the thread context using the hardware state and the software state before the full context is pushed by the CPU architecture, further comprises checking memory locations for at least one piece of the thread context and combining the pieces of the thread context to create the thread context.

8. The method of claim 7, wherein checking memory locations includes checking at least a stack and a register.

9. The method of claim 5, wherein determining the software state based on the hardware state further comprises stepping through possible software states based on the hardware state to determine the software state at the time of the interrupt.

10. The method of claim 6, further comprising delaying determining the thread context when the software state is in a critical kernel mode state.

11. A computer-readable medium having computer-executable instructions for capturing a thread context at a time of interrupt for a thread, comprising:
generating an interrupt;
capturing the thread context before a full context is pushed by the CPU architecture; and
obtaining a call stack from the thread context.

12. The computer-readable of claim 11, further comprising injecting code into the thread to capture the thread context.

13. The computer-readable of claim 12, further comprising boosting a priority of the thread such that the thread remains uninterrupted for a period of time.

14. The computer-readable of claim 11, further comprising: determining a hardware state of the CPU architecture at the time of the interrupt; and determining a software state based on the hardware state.

15. The computer-readable medium of claim 14, wherein the hardware state relates to an operating mode of the processor at the time of interrupt.

16. The computer-readable medium of claim 15, further comprising determining a level of nesting that relates to how many times the thread has been interrupted.

17. The computer-readable medium of claim 15, wherein capturing the thread context further comprises checking memory locations for at least one piece of the thread context and combining the pieces of the thread context to create the thread context.

18. The computer-readable medium of claim 17, wherein checking the memory locations includes checking at least a stack and a register.

19. The computer-readable medium of claim 18, wherein determining the software state based on the hardware state further comprises stepping through possible software states based on the hardware state to determine the software state at the time of the interrupt.

20. The computer-readable medium of claim 21, further comprising delaying determining the thread context when the software state is in a critical kernel mode state.

21. A system having a CPU architecture for capturing a thread context, comprising:
a processor and a computer-readable medium;
an operating environment stored on the computer-readable medium and executing on the processor;
an thread that is executing on the system, wherein the thread is being profiled; and
a profiler application operating under the control of the operating environment and operative to perform actions for capturing a thread context at a time of interrupt for the thread, comprising:
generating an interrupt;
capturing the thread context before a full context is pushed by the CPU architecture and
obtaining a calls tack from the thread context.

22. The system of claim 20, wherein the profiler is further configured to inject code into the thread to capture the thread context.

23. The system of claim 22, further comprising boosting a priority of the thread such that the thread remains uninterrupted for a period of time.

24. The system of claim 20, wherein the profiler is further configured to: determine a hardware state of the CPU architecture at the time of the interrupt; and determine a software state based on the hardware state.

25. The system of claim 24, wherein the hardware state is an operating mode of the processor at the time of interrupt.

26. The system of claim 21, further comprising determining a level of nesting that relates to how many times the thread has been interrupted.

27. The system of claim 20, wherein capturing the thread context further comprises checking memory locations for at least one piece of the thread context and combining the pieces of the thread context to create the thread context.

28. The system of claim 27, wherein checking the memory locations includes checking at least a stack and a register.

29. The system of claim 26, wherein determining the software state based on the hardware state further comprises stepping through possible software states based on the hardware state to determine the software state at the time of the interrupt.

30. The system of claim 26, further comprising delaying determining the thread context when the software state is in a critical kernel mode state.
